(19) United States
(12) Patent Application Publication
(10) Pub. No.: US 2016/0239685 A1
(43) Pub. Date: Aug. 18, 2016

(54) HYBRID SECURE NON-VOLATILE MAIN MEMORY

(71) Applicant: HEWLETT-PACKARD DEVELOPMENT COMPANY, L.P., Houston, TX (US)

(72) Inventors: Sheng Li, Palo Alto, CA (US); Jichuan Chang, Palo Alto, CA (US); Parthasarathy Ranganathan, Palo Alto, CA (US); Doe Hyun Yoon, Palo Alto, CA (US)

(21) Appl. No.: 14/900,665

(22) PCT Filed: Jul. 31, 2013
(86) PCT No.: PCT/US2013/053046

§ 371 Date: Dec. 22, 2015

(51) Int. Cl. G06F 21/79; G11C 7/10; G06F 21/72; G11C 14/00; G11C 13/00; G11C 7/24; G11C 11/4078

(52) U.S. Cl. CPC G06F 21/79; G11C 7/24; G11C 7/1006; G11C 11/4078; G11C 14/0036; G11C 13/0004; G11C 13/0059; G06F 21/72

(57) ABSTRACT

According to an example, a hybrid secure non-volatile main memory (HSNVMM) may include a non-volatile memory (NVM) to store a non-working set of memory data in an encrypted format, and a dynamic random-access memory (DRAM) buffer to store a working set of memory data in a decrypted format. A cryptographic engine may selectively encrypt and decrypt memory pages in the working and non-working sets of memory data. A security controller may control memory data placement and replacement in the NVM and the DRAM buffer based on memory data characteristics that include clean memory pages, dirty memory pages, working set memory pages, and non-working set memory pages. The security controller may further provide incremental encryption and decryption instructions to the cryptographic engine based on the memory data characteristics.

### BACKGROUND

Non-volatile memory (NVM) technologies such as memristors, phase-change random access memory (PCRAM), and spin-transfer torque random-access memory (STT-RAM) provide the possibility of building relatively fast and inexpensive non-volatile main memory (NVMM) systems. These NVMM systems can be used to implement, for example, instant-on systems, high-performance persistent memories, and single-level of memory and storage. NVMM systems are typically subject to security vulnerability since information in these systems remains thereon after the systems are powered down. This security vulnerability can be used for unauthorized extraction of information from the NVMM systems.

### BRIEF DESCRIPTION OF DRAWINGS

Features of the present disclosure are illustrated by way of example and not limited in the following figure(s), in which like numerals indicate like elements, in which:

FIG. 1 illustrates an architecture of a hybrid secure non-volatile main memory (HSNVMM), according to an example of the present disclosure;

FIG. 2 illustrates a security controller for the HSNVMM of FIG. 1, according to an example of the present disclosure;

FIG. 3 illustrates a method for implementing the HSNVMM of FIG. 1, according to an example of the present disclosure;

FIG. 4 illustrates further details of the method for implementing the HSNVMM of FIG. 1, according to an example of the present disclosure; and

FIG. 5 illustrates a computer system, according to an example of the present disclosure.

### DETAILED DESCRIPTION

For simplicity and illustrative purposes, the present disclosure is described by referring mainly to examples. In the following description, numerous specific details are set forth in order to provide a thorough understanding of the present disclosure. It will be readily apparent however, that the present disclosure may be practiced without limitation to these specific details. In other instances, some methods and structures have not been described in detail so as not to unnecessarily obscure the present disclosure.

Throughout the present disclosure, the terms “a” and “an” are intended to denote at least one of a particular element. As used herein, the term “includes” means includes but not limited to, the term “including” means including but not limited to. The term “based on” means based at least in part on.

Compared to volatile memories, non-volatile memory (NVM) technologies used to implement non-volatile main memory (NVMM) systems can add vulnerability to a system using such memory types. For example, absent security features, a NVM may be taken offline and scanned separately from a NVMM system to obtain sensitive information even when the NVMM system is powered off since data remains in the NVM. An example of a technique of providing security in NVMM systems includes encryption. However, encryption may negatively impact performance characteristics of a NVMM system. For example, in contrast to hard drive encryption where encryption latency may account for a relatively small percentage of total disk access latency, hardware encryption latency may account for a relatively high percentage of main memory access latency.

According to an example, a hybrid secure non-volatile main memory (HSNVMM) is disclosed herein. The HSNVMM may provide a secure and high performance main memory that is self-contained. For example, the encryption ability of the HSNVMM may be independent of a particular processor platform, or instruction set architecture (ISA), and may need no specific changes to processor architecture. The HSNVMM may provide a drop-in solution on a wide range of platforms ranging, for example, from servers, laptops, and mobile phones, to embedded systems. The HSNVMM may also provide a drop-in replacement for volatile memory systems (e.g., dynamic random-access memory (DRAM)). The HSNVMM may provide for security and encryption with minimal performance overhead. The HSNVMM may also be used to target data-centric datacenters to provide a secure solution for in-memory workloads with large working data sets.

The HSNVMM may use incremental encryption as described herein. For example, with respect to bulk encryption and incremental encryption, for a DRAM based main memory, when a system is powered down, there is a brief time period (e.g., from one-half second to a few seconds) called a vulnerability window (VW) in which the main memory still retains information. The HSNVMM may provide for matching and/or reduction of the VW compared to a DRAM based system. Bulk encryption may be defined as encryption of the entire memory when a system is powered down. Incremental encryption may include maintaining most of the memory encrypted at all times, so that a small percentage of memory pages need to be encrypted on power down. With bulk encryption on NVMM, encrypting the entire main memory may take a relatively long time (e.g., tens of seconds, or even longer), hence the VW may be much greater than that of DRAM. In addition, with bulk encryption, the VW may be determined as a function of the memory capacity per memory module and write bandwidth. The VW may grow when larger main memory is provisioned in future systems. For NVMM with incremental encryption, different parts of memory may be encrypted at different times so that the working set data is decrypted and the remaining memory data, which is typically much larger, is in an encrypted form. Thus, for NVMM with incremental encryption, at any given time, most of the memory is in an encrypted form. Because a small fraction of the memory needs to be encrypted at power down, the VW may be much shorter, matching or excelling that of DRAM systems.

With incremental encryption, the fraction of main memory to be encrypted may be determined as a function of the working set (i.e., the memory that is accessed frequently by applications) of applications running when a system is powered down, and the fraction of main memory to be encrypted may not depend on the size of the total physical main memory. Therefore, unlike bulk encryption, the VW may not grow linearly with the size of the total physical memory. However, general incremental encryption may not be sufficient, as in-memory data workloads may include very large working sets (e.g., from gigabytes (GBs) to hundreds of GBs). With such a large working set, general incremental encryption may still incur a very large VW and thus fail to meet security needs.

The HSNVMM may include a working set predictor (WSP) to facilitate incremental encryption, and to perform the tasks of predicting cold memory pages that will not belong to the working set, and future hot memory pages that will belong to the working set. With respect to prediction of cold memory pages that will not belong to the working set, the cold memory pages may need to be encrypted and stored back to a NVM of the HSNVMM. This ensures that the majority of the memory in the HSNVMM may be encrypted all the time. With respect to prediction of the future hot memory pages that will belong to the working set, the predicted-to-be-hot memory pages may need to be pre-decrypted. This provides for hiding of decryption latency by ensuring memory accesses will generally use memory pages that are decrypted in advance.

The HSNVMM WSP may also account for mispredictions. For example, mispredictions on cold memory pages may cause cold memory pages (i.e., encrypted memory pages) to get future memory accesses. For such mispredicted cold memory pages, on-demand encryption may be needed for each memory access. Further, future memory accesses may also be residue memory accesses to a cold memory page. Thus, decrypting an entire memory page upon a memory access may be less efficient, and the HSNVMM may include a cryptographic engine to decrypt a demanded cache block as opposed to an entire memory page. Alternatively, if there are many memory accesses to an encrypted cold page, the HSNVMM cryptographic engine may decrypt an entire memory page to hide any decryption latency for future memory accesses to the same memory page. Thus, the HSNVMM WSP may maintain a threshold of the on-demand decryptions to control when to decrypt an entire memory page that is predicted as cold and thus encrypted. A memory page decrypted entirely in this case may be denoted an on-demand decrypted memory page. Mispredictions may also occur when predicting hot pages. For example, when many memory pages are predicted to be hot (i.e., pre-decrypted) but receive very few memory accesses, the total number of decrypted memory pages may be over-inflated. This may result in security issues, such as, for example, a larger VW and reduced memory protection.

The HSNVMM disclosed herein may thus provide, for example, a self-contained, secure, and high performance NVM based main memory system for data-centric datacenters. The HSNVMM disclosed herein may provide benefits, such as, for example, improved security for NVM based main memory systems, and improvements in performance and wear-leveling. The HSNVMM disclosed herein may also support the separation of clean and dirty decrypted memory pages during transitions between encrypted and decrypted formats, which may provide for reduction of the VW for higher security standards, and thus suitability for in-memory workloads and data-centric datacenters. The HSNVMM may also provide security guarantees by actively encrypting memory pages and deep powering down of the DRAM buffer thereof when a HSNVMM based system is idle. This may ensure the memory security of an online system in addition to the security of an offline system. The HSNVMM may include a data replacement policy to ensure security guarantees, and to simultaneously maximize performance and wear-leveling improvements. The HSNVMM may use processor hints on sensitive/non-sensitive data regions, which may further improve HSNVMM based system security and performance. The HSNVMM may also be implemented transparent to software, and may be used for memory architecture with a buffer-on-board (BoB).

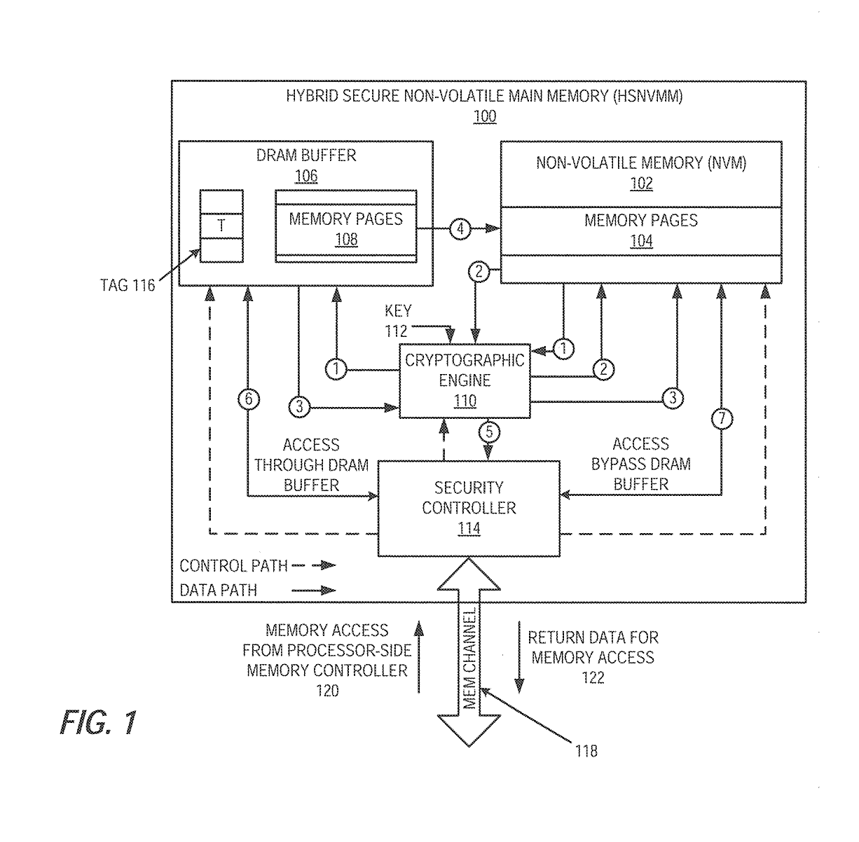

FIG. 1 illustrates an architecture of a hybrid secure non-volatile main memory (HSNVMM) 100, according to an example. Referring to FIG. 1, the HSNVMM 100 is depicted as including a NVM 102 to generally store a non-working set of memory data (e.g., memory pages 104) in an encrypted format. A volatile memory, such as a dynamic random-access memory (DRAM) buffer 106, may generally store a working set of memory data (e.g., memory pages 108) in a decrypted format. A cryptographic engine 110 may encrypt and decrypt memory data. The cryptographic engine 110 may receive an encryption/decryption key 112 for encrypting and decrypting the memory data. A security controller 114 may control memory page placement/replacement (hereinafter denoted “(re)placement”) in the NVM 102 and the DRAM buffer 106. A tag portion 116 of the DRAM buffer 106 may be used to locate an actual memory page. A memory channel 118 may provide for memory access from a processor side memory controller as shown at 120, and return data for memory access as shown at 122. For FIG. 1, broken lines with arrows may indicate control flow paths, and solid lines with arrows may indicate data flow paths.

The components of the HSNVMM 100 that perform various other functions in the HSNVMM 100, may comprise machine readable instructions stored on a non-transitory computer readable medium. In addition, or alternatively, the components of the HSNVMM 100 may comprise hardware or a combination of machine readable instructions and hardware. For example, the components of the HSNVMM 100 may be implemented using an application-specific integrated circuit (ASIC) and/or a microprocessor on the HSNVMM 100 that runs a preloaded code.

Incremental encryption for the HSNVMM 100 is described with reference to FIG. 1.

The HSNVMM 100 may include incremental encryption for suitability, for example, for in-memory workloads and data-centric datacenters that use very large working set memory. The incremental encryption may be provided by using the NVM 102 and the DRAM buffer 106 to separate clean and dirty memory pages in a working set, using support hints from processors, and/or using a data (re)placement policy for the NVM 102 and the DRAM buffer 106.

Use of the NVM 102 and the DRAM buffer 106 to separate clean and dirty memory pages in a working set is described with reference to FIG. 1.

With respect to using the NVM 102 and the DRAM buffer 106 to separate clean and dirty memory pages in a working set, when applications access a working set memory, generally, greater than one-half of the accesses may be reads. Therefore, a majority of the memory pages in the working set may be clean (i.e., no memory writes to change data values) memory pages. Since the working set memory pages are in a decrypted format, these memory pages need to be (re)encrypted when a system using the HSNVMM 100 is powered off. However, (re)encrypting clean memory page may waste time and energy. Moreover, encrypting a large number of clean memory pages may significantly increase the size of the VW. Thus, for the HSNVMM 100, the security controller 114 may separate clean and dirty memory pages by using the NVM 102 and the DRAM buffer 106. The decrypted working set (e.g., the memory pages 108) may be generally stored in the DRAM buffer 106 and NVM 102 may generally store encrypted pages (e.g., the memory pages 104), unless the DRAM buffer 106 overflows. During power-off of a system using the HSNVMM 100, the dirty memory pages in the DRAM buffer 106 may need to be encrypted and stored back to NVM 102, and the clean pages may remain in the DRAM buffer 106 and disappear since the DRAM buffer 106 is volatile. This approach may reduce the time needed to (re)encrypt memory pages during power-off of a system using the HSNVMM 100 so as to better match the VW of the DRAM buffer 106.

Use of the NVM 102 and the DRAM buffer 106 to separate clean and dirty memory pages in the working set may also provide improvement of the security level of incremental encryption during the time a system using the HSNVMM 100 is not powered down. For example, when a system using the HSNVMM 100 is idle, the HSNVMM 100 may encrypt the dirty memory pages in the DRAM buffer 106, store the encrypted memory pages back to the NVM 102, and place the DRAM buffer 106 in a deep power down mode. Since the DRAM buffer 106 in the deep power down mode does not retain data, the idle system may include all data encrypted and stored in the NVM 102. If a system using the HSNVMM 100 is compromised, the memory pages in the NVM 102 are already encrypted and secured even though the system is still powered on.

Use of support hints from a processor is described with reference to FIG. 1.

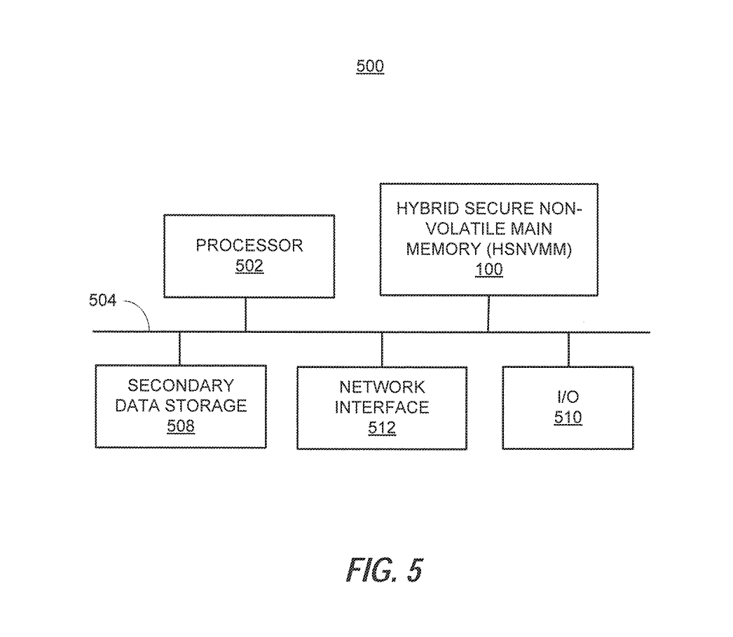

With respect to incremental encryption based on using the NVM 102 and the DRAM buffer 106 and using support hints from a processor, the security controller 114 may use hints from a processor to improve the HSNVMM 100 performance and efficiency. For example, together with each memory access request, a processor (e.g., the processor 502 of FIG. 5) may send additional information such as whether a destination memory page is sensitive, and thus needs to be encrypted, or not sensitive. Generally, since not all memory data is sensitive, by identifying and encrypting sensitive data, the encryption overhead may be further reduced.

For the HSNVMM 100, the NVM 102 may function as a primary storage media to store a non-working set of memory data (e.g., the memory pages 104) in an encrypted format, and the DRAM buffer 106 may store a working set of memory data (e.g., the memory pages 108) in a decrypted format. Thus, the DRAM buffer 106 may function as a volatile cache for the NVM 102. The DRAM buffer 106 may be arranged as a set associative cache with cache line size equal to a NVM memory page (e.g., 4 KB) by default. The DRAM buffer 106 may also support multiple granularities, for example, from a memory page to a 64B cache block (with minimal encryption granularity being 64B) to facilitate improved use of the DRAM buffer 106 but with higher implementation overhead. The DRAM buffer 106 may also be organized as direct mapped or fully associative caches.

Since the DRAM buffer 106 generally includes different data formats compared to the NVM 102, the HSNVMM 100 may include a data (re)placement policy to satisfy the needs for security and performance. The metric for security may be based on a vulnerability window (VW), which may be defined as the time period in which the NVM 102 still retains un-secure information when a system using the HSNVMM 100 is powered down. The size of the VW may depend on the total number of memory pages (i.e., based on their status, location, and sensitivity) that need to be encrypted during system power-off of a system using the HSNVMM 100. The target VW may be determined by the security needs and/or the backup power (e.g., the size of a super-capacitor) on the HSNVMM 100 and/or a system using the HSNVMM 100. Based on the security needs and/or backup power, the VW may be set, for example, by a system basic input/basic output (BIOS), and/or system administers.

The data (re)placement policy for the HSNVMM 100 is described with reference to FIG. 1.

The security controller 114 may use the data (re)placement policy for the NVM 102 and the DRAM buffer 106, such that the DRAM buffer 106 may be used to store the working set of memory data in a decrypted format, while the NVM 102 may provide the primary storage for the entire memory data in an encrypted format (unless the DRAM buffer 106 overflows as discussed herein). Thus, the NVM 102 may be relatively larger in storage capacity compared to the DRAM buffer 106. The DRAM buffer 106 may also be considered as a volatile cache for NVM media. However, data in the NVM 102 and the DRAM buffer 106 may be in different formats. For example, data in the NVM 102 may be encrypted (unless the DRAM buffer 106 overflows), and data in the DRAM buffer 106 may be decrypted. The data types may include, for example, encrypted sensitive data, decrypted sensitive data, and decrypted insensitive data. A processor (e.g., the processor 502) may be used to provide hints on whether data is sensitive or insensitive. Moreover, for each data type, the memory pages may be clean or dirty.

From a security perspective, the security controller 114 may command storage of clean memory pages of sensitive data in the DRAM buffer 106 so that the clean pages can be readily discarded when a system using the HSNVMM 100 is powered off or enters an idle state. Dirty memory pages of sensitive data may be either stored in the DRAM buffer 106 or in the NVM 102, and may need to be re-encrypted when a system using the HSNVMM 100 is powered off or enters idle state. Further, insensitive data pages may need no encryption and may be placed in either the DRAM buffer 106 or the NVM 102.

Implications of the performance, energy, and/or endurance differences between the DRAM buffer 106 and the NVM 102 may add complexity to data (re)placement for the HSNVMM 100. For example, the DRAM buffer 106 and the NVM 102 may have comparable performance and energy efficiency on reads, whereas in certain instances, a NVM such as a phase change random-access memory (PCRAM) may have a higher overhead on performance and energy efficiency compared to a DRAM. Moreover, some NVM memory types, such as, for example, PCRAM and memristor based NVMs, may prefer comparatively less writes. The security controller 114 may use the data (re)placement policy for the NVM 102 and the DRAM buffer 106 to address the foregoing aspects, and to satisfy security needs, while optimizing performance, energy efficiency, and endurance for the HSNVMM 100.

With respect to the data (re)placement policy, the security controller 114 may control the memory page (re)placement in the DRAM buffer 106. When a new memory page needs to be decrypted, the security controller 114 may first compute the current VW size (with the new memory page), compare the current VW size against a target VW size, and then select a victim memory page for eviction out of the DRAM buffer 106. The VW size may be adjusted and/or observed based on user needs.

With respect to eviction, if a current VW (with the new memory page) is smaller than a target VW, both dirty and clean decrypted pages may be stored in the DRAM buffer 106. Further, dirty pages may be prioritized over clean pages to be stored in the DRAM buffer 106 to improve performance when conflicts occur, assuming that the DRAM buffer 106 has superior write performance and/or endurance compared to the NVM 102. This indicates that the decrypted memory pages may overflow to the NVM 102 without encryption if they are predicted to be still in the working set (e.g., the memory pages 108) since there is sufficient time to encrypt the decrypted pages when a system using the HSNVMM 100 is powered off. Further, the memory access to the decrypted memory pages may bypass the DRAM buffer 106 to access the NVM 102 directly. Since the clean memory pages are selected as victims first to overflow to the NVM 102, decrypted memory pages in the NVM 102 may generally be clean pages, and the memory accesses to the NVM 102 may generally be reads, including clean memory pages in the NVM 102 may result in relatively small overhead.

With respect to eviction, if the current VW (with the new memory page) is larger than the target VW, clean memory pages may be prioritized over dirty memory pages to be stored in the DRAM buffer 106. This may ensure a smaller set of memory pages need to be encrypted since the clean memory pages may be discarded when a system using the HSNVMM 100 is powered off. When the current VW is larger than the target VW, this means that the predicted working set (i.e., the memory pages 108) is larger than the capacity (including associativity effects) of the DRAM buffer 106. Thus, the security controller 114 may also provide for encryption of memory pages evicted from the DRAM buffer 106, and future subsequent access to the memory pages may incur decryption overhead.

When an encrypted cold memory page in the NVM 102 is accessed, the cryptographic engine 110 may first decrypt the demanded cache blocks to serve the memory request without decrypting the entire memory page until the total number of memory accesses on the memory page reaches a predetermined threshold. Thereafter, the entire memory page may be decrypted (the memory page may be called as an on-demand decrypted page), and stored in the NVM 102 or the DRAM buffer 106 depending on the eviction policy. The security controller 114 may also minimize the performance overhead by prioritizing on-demand decrypted pages over pre-decrypted pages to store in the DRAM buffer 106, since the on-demand decrypted pages may already receive many memory accesses to reach a predetermined threshold. However, well-predicted pre-decrypted memory pages may be penalized if they are generally under-prioritized. Thus, after the pre-decrypted memory pages receive many memory accesses, the pre-decrypted memory pages may be marked as on-demand decrypted pages.

The security controller 114 may also provide for proactive eviction. When a memory page is predicted to be cold (i.e., not in the working set), the memory page may be proactively evicted out of the DRAM buffer 106, encrypted, and stored back to the NVM 102 to hide the eviction latency. Thus, compared to a cache that includes evictions on-demand, the (re)placement policy used by the security controller 114 may also include proactive eviction. Further, a cold memory page may stay in the DRAM buffer 106 until on-demand eviction, which may reduce the penalty on cold memory page misprediction when the conflict rate in the DRAM buffer 106 is low.

With respect to eviction, if the processor (e.g., the processor 502 of FIG. 5) marks insensitive data, the clean insensitive memory pages may be placed in the NVM 102 to reduce competition on the resources of the DRAM buffer 106 since read operations on the NVM 102 generally cause minimal overhead. Dirty insensitive memory pages may be stored in the DRAM buffer 106 to optimize for performance and endurance of the HSNVMM 100 when the time difference between a current VW and a target VW exceeds a predetermined threshold. If the time difference between the current VW and the target VW is less than the predetermined threshold, the dirty insensitive memory pages may be stored in the NVM 102 to ensure the security guarantees of sensitive data. Further, when selecting a victim for eviction, the least recently used (LRU) criterion may be applied as a final tie breaker. The data (re)placement policy may thus to satisfy the needs for security and performance.

Referring to FIG. 1, with respect to the data (re)placement policy between the NVM 102 and the DRAM buffer 106, there may be seven different data flow paths between the NVM 102 and the DRAM buffer 106. At flow path 1, memory pages from the memory pages 104 may be brought from the NVM 102, decrypted, and stored in the DRAM buffer 106. At flow path 2, memory pages from the memory pages 104 may be brought from the NVM 102, decrypted, and stored back in the NVM 102. At flow path 3, decrypted memory pages from the memory pages 108 may be evicted out of the DRAM buffer 106, encrypted, and stored back in the NVM 102. At flow path 4, decrypted memory pages from the memory pages 108 may be evicted from the DRAM buffer 106 directly to the NVM 102 without encryption. At flow path 5, when an encrypted cold memory page receives a memory access, the cryptographic engine 110 may first decrypt the demanded cache block to serve the memory request without decrypting the entire memory page. At flow path 6, when decrypted memory pages are in the DRAM buffer 106, memory accesses may be directed to the DRAM buffer 106. At flow path 7, when decrypted memory pages are not in the DRAM buffer 106 but in the NVM 102, memory accesses may bypass the DRAM buffer 106 and go directly to the NVM 102.

The cryptographic engine 110 is described with reference to FIG. 1.

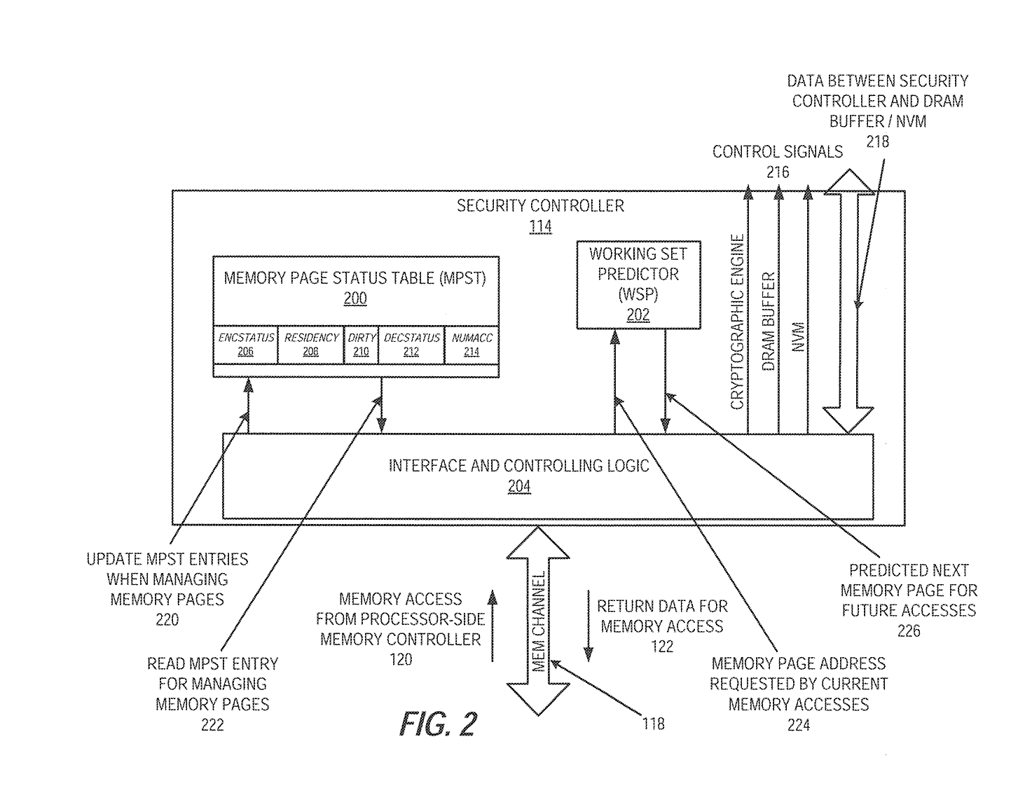

Referring to FIGS. 1 and 2, the cryptographic engine 110 may encrypt and decrypt memory data (e.g., the memory pages 104, 108). The cryptographic engine 110 may use, for example, advanced encryption standard (AES) to encrypt and decrypt the memory data. The cryptographic engine 110 may encrypt and decrypt a single cache block without encrypting and decrypting an entire memory page, such that the HSNVMM 100 may service memory accesses on an encrypted memory page without decrypting the entire memory page. The encryption/decryption key 112 may be generated by a processor (e.g., the processor 502 of FIG. 5) with external seed such as, for example, a user password and/or fingerprints. After the key 112 is generated, the key 112 may be downloaded to a volatile memory (e.g., SRAM) in the cryptographic engine 110. After a system using the HSNVMM 100 is powered off, the key 112 may be lost. For example, after a system using the HSNVMM 100 is powered off, an unauthorized user cannot produce a valid external seed and thus cannot regenerate the correct key, which ensures the security of the HSNVMM 100. A super capacitor may be used to provide sufficient power to ensure the completion of encryption of the working set during unexpected power failure.

The security controller 114 is described with reference to FIGS. 1 and 2.

FIG. 2 illustrates further details of the security controller 114 for the HSNVMM 100 of FIG. 1, according to an example of the present disclosure. The security controller 114 may include a memory page status table (MPST) 200 that may be implemented, for example, using a static random-access memory (SRAM), or a register-based array. A working set predictor (WSP) 202 for a next memory page may be responsible for finding an active working set. The WSP 202 may be implemented, for example, based on Markov prefetching.

The security controller 114 may be implemented, for example, by a buffer-on-board (BoB) design. For example, the security controller 114 may be implemented as a load reduced (LR) buffer in a LR dual in-line memory module (DIMM) that is the interface between a processor (e.g., the processor 502) and the HSNVMM 100. The security controller 114 may include the MPST 200, the WSP 202, and the interface and controlling logic 204.

The WSP 202 may determine the current working set. As discussed above, overestimating the working set may cause unnecessary memory pages to be decrypted, which may lead to a relatively larger VW since more memory pages need to be (re)encrypted when a system using the HSNVMM 100 is powered off or enters an idle state. Underestimating the working set may cause memory pages in the working set to be encrypted, which may lead to extra performance overhead due to the decryption latency when memory accesses arrive at encrypted memory pages. The WSP 202 may be based, for example, on access count per time interval to determine whether a memory page is cold (i.e., not an active working set). With respect to predicting future working set pages to hide encryption latency by pre-decryption, prefetching techniques such as, for example, Markov prefetching may be used. The WSP 202 may be interval based, and may therefore collect information on each time interval (e.g., 10 billion processor cycles) and predict the working set for a next interval.

The MPST 200 may be a volatile memory structure (e.g., SRAM) that may assist the interface and controlling logic 204 by keeping track of the status of each memory page. The MPST 200 may include an encryption status (EncStatus) field 206 (e.g., 1-bit field) that indicates whether a memory page is currently encrypted or not. A residency field 208 (e.g., 1-bit field) may indicate whether a memory page is currently in the NVM 102 or the DRAM buffer 106. For example, some decrypted memory pages may be in the NVM 102 because of scheduling. The residency field 208 may provide first level information about the location of a memory page, and once a memory page is in the DRAM buffer 106, the tag portion 116 of the DRAM buffer 106 may be used to locate the actual memory page. A dirty field 210 (e.g., 1-bit field) may indicate whether a memory page is dirty or not. A decryption status (DecStatus) field 212 (e.g., 1-bit field) may indicate whether a memory page is decrypted because of pre-decryption or on-demand prediction. A multi-bit number of access (NumAcc) field 214 may record a number of times a memory page has been accessed in a previous interval. The MPST 200 may also include other fields depending on the prediction process used by the WSP 202.

The interface and controlling logic 204 may manage the data movement and (re)placement between the NVM 102 and the DRAM buffer 206 using the information in the MPST 200 and the WSP 202. The interface and controlling logic 204 may also control the cryptographic engine 110 to perform encryption/decryption when necessary according to scheduling. The interface and controlling logic 204 may also update the MPST 200 after each management event. Since on-demand decrypted memory pages may be prioritized over pre-decrypted memory pages, the interface and controlling logic 204 may use the DecStatus field 212 in the MPST 200 to distinguish between on-demand decrypted memory pages and pre-decrypted memory pages when they are first decrypted. However, well-predicted pre-decrypted memory pages may be penalized if they are always under-prioritized over the on-demand decrypted memory pages. Thus, the interface and controlling logic 204 may track the number of accesses to each memory page in every interval. If the pre-decrypted memory pages receive sufficient memory accesses as a threshold in a previous interval, the interface and controlling logic 204 may change the DecStatus field 212 to mark the memory page as an on-demand decrypted page. The NumAcc field 214 may be updated upon every memory access to the HSNVMM 100, and the dirty field 210 may be updated upon the first writes to a memory page. The EncStatus field 206, residency field 208, and the DecStatus field 212 may be updated at each interval or when an event (e.g., eviction, cache line insertion in the DRAM buffer, etc.) occurs.

The interface and controlling logic 204 may include control signal paths as illustrated by the control signals 216 for the cryptographic engine 110, the DRAM buffer 106, and the NVM 102. A data channel 218 may be used for data transfer between the security controller 114, the DRAM buffer 106, and the NVM 102. A channel 220 may be used to update MPST entries when managing memory pages. A channel 222 may be used to read MPST entries for managing memory pages. A channel 224 may be used for memory page addresses requested by current memory accesses. Further, a channel 226 may be used to predict next memory pages for future accesses.

The HSNVMM 100 may be implemented as shown in the example of FIG. 1 with the NVM 102 and the DRAM buffer 106 on the same memory module, or alternatively, as disaggregated DRAM and NVM pools where the near DRAM pool may be used as the buffer of a far NVM pool, and vice-versa. Moreover, the HSNVMM 100 may be implemented as separated components including the NVM 102, the DRAM buffer 106, the cryptographic engine 110, and the security controller 114, or may be integrated in a single chip or package.

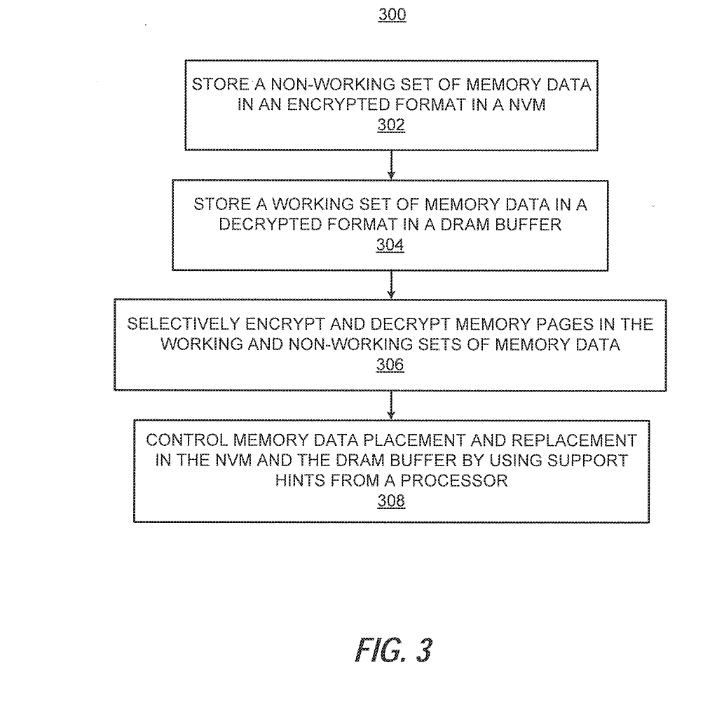

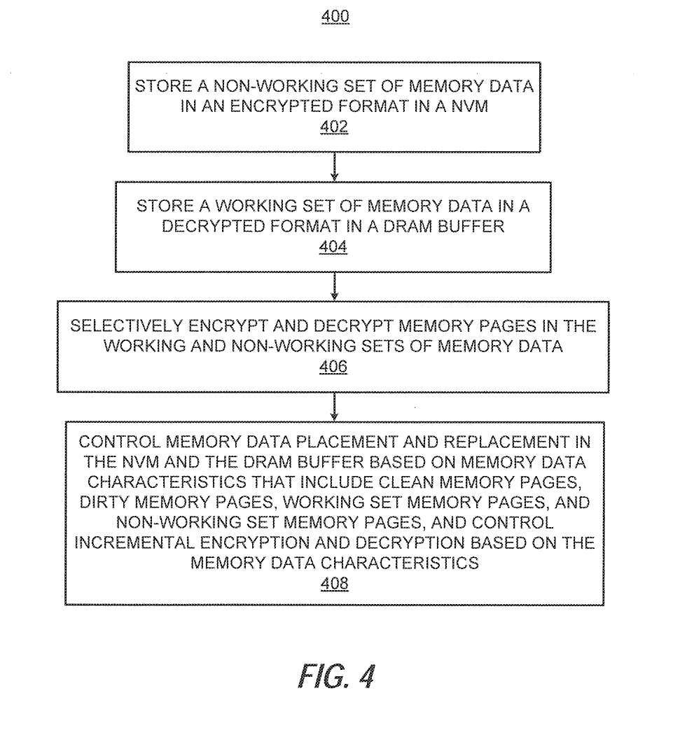

FIGS. 3 and 4 respectively illustrate flowcharts of methods 300 and 400 for implementing a HSNVMM, corresponding to the example of the HSNVMM 100 whose construction is described in detail above. The methods 300 and 400 may be implemented on the HSNVMM 100 with reference to FIGS. 1 and 2 by way of example and not limitation. The methods 300 and 400 may be practiced in other apparatus.

Referring to FIG. 3, for the method 300, at block 302, a non-working set of memory data (e.g., the memory pages 104) may be stored in an encrypted format in a NVM (e.g., the NVM 102).

At block 304, a working set of memory data (e.g., the memory pages 108) may be stored in a decrypted format in a DRAM buffer (e.g., the DRAM buffer 106).

At block 306, memory pages in the working and non-working sets of memory data may be selectively encrypted and decrypted (e.g., by the cryptographic engine 110).

At block 308, memory data placement and replacement in the NVM and the DRAM buffer may be controlled, for example, by the security controller 114, by using support hints from a processor (e.g., the processor 502) and (re)placement policy as described above. The support hints may include an indication of whether a memory page in the working set of memory data is sensitive or insensitive. Based on an indication that the memory page in the working set of memory data is sensitive, the memory page may be encrypted.

Referring to FIG. 4, for the method 400, at block 402, a non-working set of memory data may be stored in an encrypted format in a NVM (e.g., the NVM 102).

At block 404, a working set of memory data may be stored in a decrypted format in a DRAM buffer (e.g., the DRAM buffer 106).

At block 406, memory pages in the working and non-working sets of memory data may be selectively and incrementally encrypted and decrypted (e.g., by the cryptographic engine 110).

At block 408, memory data placement and replacement in the NVM and the DRAM buffer may be controlled based on memory data characteristics that include clean memory pages, dirty memory pages, working set memory pages, and non-working set memory pages, and by controlling incremental encryption and decryption based on the memory data characteristics.

According to another example, memory data placement and replacement in the NVM and the DRAM buffer may be controlled by further determining if a system using the HSNVMM 100 is idle, and if the system using the HSNVMM 100 is idle, using a cryptographic engine (e.g., the cryptographic engine 110) to encrypt the dirty memory pages in the DRAM buffer, storing the encrypted memory pages in the NVM, and placing the DRAM buffer in a power down mode.

According to another example, memory data placement and replacement in the NVM and the DRAM buffer may be controlled by further using support hints from a processor, where the support hints include an indication of whether a memory page in the working set of memory data is sensitive or insensitive, and based on an indication that the memory page in the working set of memory data is sensitive, using the cryptographic engine to encrypt the memory page. According to a further example, memory data placement and replacement in the NVM and the DRAM buffer may be controlled by further using a data placement and replacement policy (i.e., the foregoing data (re)placement policy) to store clean memory pages of sensitive data in the DRAM buffer. Memory data placement and replacement in the NVM and the DRAM buffer may be controlled by further using the data (re)placement policy to store clean memory pages of insensitive data in the NVM.

According to another example, memory data placement and replacement in the NVM and the DRAM buffer may be controlled by further using the data (re)placement policy to store dirty memory pages of sensitive data in the DRAM buffer or the NVM, and using the cryptographic engine to re-encrypt the dirty memory pages of sensitive data when a system using the HSNVMM 100 is powered off or enters an idle state. According to a further example, memory data placement and replacement in the NVM and the DRAM buffer may be controlled by further using the data (re)placement policy to determine if a memory page is to be decrypted, computing a current VW size, comparing the current VW size to a target VW size, and based on the comparison, selecting a memory page victim for eviction from the DRAM buffer.

According to another example, memory data placement and replacement in the NVM and the DRAM buffer may be controlled by further using the data (re)placement policy to determine if a memory page is to be decrypted, computing a current VW size, comparing the current VW size to a target VW size, and if the current VW is less than the target VW, storing clean and dirty decrypted memory pages in the DRAM buffer. According to a further example, memory data placement and replacement in the NVM and the DRAM buffer may be controlled by further using the data (re)placement policy to determine if a memory page is to be decrypted, computing a current VW size, comparing the current VW size to a target VW size, and if the current VW is greater than the target VW, prioritizing clean memory pages over dirty memory pages for storage in the DRAM buffer.

According to another example, memory data placement and replacement in the NVM and the DRAM buffer may be controlled by further using the data (re)placement policy to predict if a memory page in the working set of memory data is cold, and if the memory page in the working set of memory data is predicted to be cold, evicting the memory page from the DRAM buffer. According to a further example, memory data placement and replacement in the NVM and the DRAM buffer may be controlled by further using the data (re)placement policy to determine when a cold memory page in the non-working set of memory data of the NVM is accessed, if a number of memory accesses on the cold memory page is less than or equal to a predetermined threshold, using the cryptographic engine to decrypt a demanded cache block of the cold memory page, and if the number of memory accesses on the cold memory page is greater than the predetermined threshold, using the cryptographic engine to decrypt the entire cold memory page.

FIG. 5 shows a computer system 500 that may be used with the examples described herein. The computer system may represent a generic platform that includes components that may be in a server or another computer system. The computer system 500 may be used as a platform for the HSNVMM 100. The computer system 500 may execute, by a processor or other hardware processing circuit, the methods, functions and other processes described herein. These methods, functions and other processes may be embodied as machine readable instructions stored on a computer readable medium, which may be non-transitory, such as hardware storage devices (e.g., RAM (random access memory), ROM (read only memory), EPROM (erasable, programmable ROM), EEPROM (electrically erasable, programmable ROM), hard drives, and flash memory).

The computer system 500 may include a processor 502 that may implement or execute machine readable instructions performing some or all of the methods, functions and other processes described herein. Commands and data from the processor 502 are communicated over a communication bus 504. The computer system also includes the HSNVMM 100. Additionally, the computer system may also include random access memory (RAM) where the machine readable instructions and data for the processor 502 may reside during runtime, and a secondary data storage 508, which may be non-volatile and stores machine readable instructions and data. The RAM and data storage are examples of computer readable mediums.

The computer system 500 may include an I/O device 510, such as a keyboard, a mouse, a display, etc. The computer system may include a network interface 512 for connecting to a network. Other known electronic components may be added or substituted in the computer system.

What has been described and illustrated herein is an example along with some of its variations. The terms, descriptions and figures used herein are set forth by way of illustration only and are not meant as limitations. Many variations are possible within the spirit and scope of the subject matter, which is intended to be defined by the following claims—and their equivalents—in which all terms are meant in their broadest reasonable sense unless otherwise indicated.

What is claimed is:

1. A hybrid secure non-volatile main memory (HSNVMM) comprising:
a non-volatile memory (NVM) to store a non-working set of memory data in an encrypted format;
a dynamic random-access memory (DRAM) buffer to store a working set of memory data in a decrypted format;
a cryptographic engine to selectively encrypt and decrypt memory pages in the working and non-working sets of memory data; and
a security controller to control memory data placement and replacement in the NVM and the DRAM buffer based on memory data characteristics that include clean memory pages, dirty memory pages, working set memory pages, and non-working set memory pages, wherein the security controller is to further provide incremental encryption and decryption instructions to the cryptographic engine based on the memory data characteristics.

2. The HSNVMM according to claim 1, wherein the DRAM buffer further comprises:
a tag portion for a memory page to locate a corresponding memory page in the NVM.

3. The HSNVMM according to claim 1, wherein the security controller, to control memory data placement and replacement in the NVM and the DRAM buffer, is to further:
determine if a system using the HSNVMM is idle; and
in response to the system using the HSNVMM being idle:
use the cryptographic engine to encrypt the dirty memory pages in the DRAM buffer,
store the encrypted memory pages in the NVM, and
place the DRAM buffer in a deep power down mode.

4. The HSNVMM according to claim 1, wherein the security controller, to control memory data placement and replacement in the NVM and the DRAM buffer, is to further:
use support hints from a processor, wherein the support hints include an indication of whether a memory page in the working set of memory data is sensitive or insensitive; and
based on an indication that the memory page in the working set of memory data is sensitive, use the cryptographic engine to encrypt the memory page.

5. The HSNVMM according to claim 1, wherein the security controller, to control memory data placement and replacement in the NVM and the DRAM buffer, is to further:
use a data placement and replacement policy to store clean memory pages of sensitive data in the DRAM buffer; and
use the data placement and replacement policy to store clean memory pages of insensitive data in the NVM.

6. The HSNVMM according to claim 1, wherein the security controller, to control memory data placement and replacement in the NVM and the DRAM buffer, is to further:
use a data placement and replacement policy to store dirty memory pages of sensitive data in the DRAM buffer or the NVM; and
use the cryptographic engine to re-encrypt the dirty memory pages of sensitive data when a system using the HSNVMM is powered off or enters an idle state.

7. The HSNVMM according to claim 1, wherein the security controller, to control memory data placement and replacement in the NVM and the DRAM buffer, is to further:
use a data placement and replacement policy to determine if a memory page is to be decrypted;
compute a current vulnerability window (VW) size;
compare the current VW size to a target VW size; and
based on the comparison, select a memory page victim for eviction from the DRAM buffer.

8. The HSNVMM according to claim 1, wherein the security controller, to control memory data placement and replacement in the NVM and the DRAM buffer, is to further:
use a data placement and replacement policy to determine if a memory page is to be decrypted;
compute a current vulnerability window (VW) size;
compare the current VW size to a target VW size; and
in response to the current VW being less than the target VW, store clean and dirty decrypted memory pages in the DRAM buffer.

9. The HSNVMM according to claim 1, wherein the security controller, to control memory data placement and replacement in the NVM and the DRAM buffer, is to further:
use a data placement and replacement policy to determine if a memory page is to be decrypted;
compute a current vulnerability window (VW) size;
compare the current VW size to a target VW size; and
in response to the current VW being greater than the target VW, prioritize clean memory pages over dirty memory pages for storage in the DRAM buffer.

10. The HSNVMM according to claim 1, wherein the security controller, to control memory data placement and replacement in the NVM and the DRAM buffer, is to further:
use a data placement and replacement policy to predict if a memory page in the working set of memory data is cold; and
in response to the memory page in the working set of memory data being predicted to be cold, evict the memory page from the DRAM buffer.

11. The HSNVMM according to claim 1, wherein the security controller, to control memory data placement and replacement in the NVM and the DRAM buffer, is to further:
use a data placement and replacement policy to determine when a cold memory page in the non-working set of memory data of the NVM is accessed;
in response to a number of memory accesses on the cold memory page being less than or equal to a predetermined threshold, use the cryptographic engine to decrypt a demanded cache block of the cold memory page; and
in response to the number of memory accesses on the cold memory page being greater than the predetermined threshold, use the cryptographic engine to decrypt the entire cold memory page.

12. The HSNVMM according to claim 1, further comprising:
a working set predictor (WSP) to determine the working set of memory data.

13. The HSNVMM according to claim 1, further comprising:
a memory page status table (MPST) to track a status of each memory page in the working and non-working sets of memory data.

14. The HSNVMM according to claim 1, wherein the HSNVMM is implemented as one of a single chip or package, as multiple discrete components that are co-located on a same memory module, and distributed across multiple memory modules.

15. A method for implementing a hybrid secure non-volatile main memory (HSNVMM), the method comprising:
storing a non-working set of memory data in an encrypted format in a non-volatile memory (NVM);
storing a working set of memory data in a decrypted format in a dynamic random-access memory (DRAM) buffer;
selectively and incrementally encrypting and decrypting memory pages in the working and non-working sets of memory data; and
controlling memory data placement and replacement in the NVM and the DRAM buffer based on memory data characteristics that include clean memory pages, dirty memory pages, working set memory pages, and non-working set memory pages, and controlling incremental encryption and decryption based on the memory data characteristics by:
using support hints from a processor, wherein the support hints include an indication of whether a memory page in the working set of memory data is sensitive or insensitive; and
based on a determination that the memory page in the working set of memory data is dirty, and based on an indication that the memory page in the working set of memory data is sensitive, encrypting the memory page.
